(19) United States
(12) Patent Application Publication
(10) Pub. No.: US 2018/0005101 A1
(43) Pub. Date: Jan. 4, 2018

(54) Method and System for Mitigating Metallic Vibration or Shaking Effects in Proximity of a RFID Reader

(71) Applicant: École de technologie supérieure, Montreal (CA)

(72) Inventors: Ammar KOUKI, Montréal (CA); Jebali CHOKRI, Montreal (CA)

(21) Appl. No.: 15/639,291

(22) Filed: Jun. 30, 2017

Related U.S. Application Data
(60) Provisional application No. 62/356,599, filed on Jun. 30, 2016.

(51) Int. Cl. G06K 19/077; G06K 19/07

(52) U.S. Cl. CPC G06K 19/07779; G06K 19/0701; G06K 19/07758

(57) ABSTRACT

A system and method for calibrating an RFID reader and for detecting an RFID tagged object when positioned in an environment having a metallic structure that is shakable with respect to an antenna loop of the RFID reader. The method determines a first current level for the antenna loop that allows detection of an RFID tag when the metallic structure is not shaking but that does not allow detection of the RFID tag when the metallic structure is shaking. The method further establishes a second current level that is lower than the first current level for the antenna loop and that allows detection of the RFID tag as the objects pass through the opening when the metallic structure is shaking or not. An operating current of the antenna loop is set according to the established second current, for post-calibration RFID tag reading using the RFID reader in the environment.

### CROSS-REFERENCE TO RELATED APPLICATIONS

The present application claims the priority of U.S. provisional patent application Ser. No. 62/356,599 filed on Jun. 30, 2016.

### TECHNICAL FIELD

The present relates to RFID readers and more particularly to a geometry of RFID readers and current control of RFID readers.

### BACKGROUND

RFID systems' hardware consists of one or more readers and passive or active tags. With passive tags the reader sends an electromagnetic signal to the tag, typically a strong sinusoidal wave at a specific frequency, and listens to the tag's response. The tag converts the received electromagnetic signal into energy that can then be used by the tag to send its stored information back to the reader. The information is transferred by modulating the carrier wave which is then captured and demodulated by the reader. In half-duplex systems, the signal sent by the reader is turned off when the tag sends back its information. In full-duplex systems on the other hand, the signal sent by the reader is continuous and the tag responds while the reader is transmitting. In general, the signal sent back by the tag is very weak, this limits the read range or reception of the signal and makes tag reading susceptible to noise. The problem we wish to address is the one of passive RFID tags used in a full-duplex system.

When an RFID reader sends a signal, which is an electromagnetic wave adapted to power a tag, any surrounding metallic structure in the vicinity of the reader will also receive the signal. When the wave hits a metallic structure, it induces electric currents in the structure that have the same frequency as the wave. Currents on metallic structure create their own fields and generate ‘reflected’ waves. If the metallic structure does not move, the reflected waves are not modulated and will not cause a problem if the tag is sufficiently far from the metallic structure. However when the current-carrying metallic structure moves, vibrates or shakes, the current distribution in the metallic structure can change with time. One important cause of such time variation can be when the metallic structure has non-contacting parts that open and close during the shaking. This in turn leads to a time-varying reflected wave, which is equivalent to a modulated signal. Therefore, if the rate of time change, i.e., modulation, of the reflected wave is comparable to the rate at which the tag sends back its information to the reader, then the vibrating or shaking metallic structure behaves as an interfering source and causes the reader to fail.

The general situation described above is found, amongst others, during the transport of live cattle in enclosed trailers having interior walls made from metal. In order to keep count of cattle embarking or disembarking from a trailer, a system uses a tag 100 that is placed on an ear of each animal 110, as presented in Prior Art FIGS. 1A and 1B. The system further has a reader 200 that is composed of a large loop antenna 210 in the form of a portal connected to an electronics card 300, as presented in Prior Art FIGS. 2A and 3. FIG. 2B shows the loop antenna 210 mounted at the rear of a cattle transport trailer 220. The frequency of operation of the system is 134 KHz. To ensure proper reading of the tags 100, the reader 200 must generate a magnetic field that is strong enough, typically around 1.2 μT, to energize the tag 100 with the help of the loop antenna 210. For a stronger magnetic field, more current must be applied to the loop antenna 210. However, when more current is applied, a stronger magnetic field reaches the metallic structure of the inner side of the trailer 220 and induces a stronger current in the metallic structure. A strong current in the metallic structure generates a stronger modulated signal than that of the tag 100, and thereby drowns the tag's 100 signal, when the interior wall structure of the trailer 220 shakes. This is precisely what happens when, for instance, live cattle embarks or disembarks from the trailer 220. Indeed, the trailer 220 is shaken as the cattle walks through the loop antenna 210, due to its weight. This leads to errors in reading the tags 100 and compromises the traceability of the animals.

### SUMMARY

According to one aspect there is a method for calibrating an RFID reader. The RFID reader has an antenna loop that defines an opening to allow passage of objects that are each tagged with an RFID tag. The antenna loop is positioned in an environment having a metallic structure that is shakable with respect to the antenna loop. The method determines a first current level for the antenna loop that allows detection of the RFID tag when the metallic structure is not shaking but that does not allow detection of the RFID tag as one the objects passes through the opening when the metallic structure is shaking. The method further establishes a second current level that is lower than the first current level for the antenna loop and that allows detection of the RFID tag as one of the objects passes through the opening when the metallic structure is shaking or when the metallic structure is not shaking. The method also sets an operative current of the antenna loop, for post-calibration RFID tag reading using the RFID reader in the metallic structure shaking environment, according to the established second current.

According to another aspect there is a method of detecting objects having an RFID tag with an RFID reader. The RFID reader has an antenna loop that defines an opening to allow passage of the objects. The antenna loop is positioned in an environment having a metallic structure that is shakable with respect to the antenna loop. The method determines a first current level for the antenna loop that allows detection of the RFID tag when the metallic structure is not shaking but that does not allow detection of the RFID tag as one object passes through the opening when the metallic structure is shaking. The method establishes a second current level that is lower than the first current level for the antenna loop and that allows detection of the RFID tag as one the objects passes through the opening when the metallic structure is shaking or when the metallic structure is not shaking. The method sets an operating current of the antenna loop according to the established second current and produces an electromagnetice wave. The method further passes an RFID tagged object through the opening as the metallic structure is shaking and detects an RFID tagged object during the shaking by powering the RFID tag of the tagged object with the electromagnetic wave and receiving a response wave produced by the powered RFID tag.

According to yet another aspect, there is an RFID reader system. The RFID reader system has an antenna loop, a controller and a receiver. The antenna loop defines a reduced passage region according to an item having an RFID tag in order to still allow the item to pass there through. The controller is connected to the antenna loop and is adapted to control a current of the antenna loop in order to produce a controlled electromagnetic field within the reduced passage region while limiting propagation of residual electromagnetic field outside the reduced passage region. Limiting the propagation of residual electromagnetic field outside the reduced passage region is to prevent inducing a current that is strong enough within a surrounding shaking metallic structure such as to produce electromagnetic waves capable of interfering with a response wave produced by the RFID tag as it is passing through the reduced passage region. The receiver is adapted to receive the response wave produced by the RFID tag as it is passing through the reduced passage region.

### BRIEF DESCRIPTION OF THE DRAWINGS

Further features and advantages of the present invention will become apparent from the following detailed description, taken in combination with the appended drawings, in which:

FIG. 1A, presents a cow's ear having affixed thereto a prior art RFID tag;

FIG. 1B, presents two unused prior art RFID tags for being affixed to a cow's ear as shown in FIG. 1A;

FIG. 2A, presents a prior art portal having an RFID reader defining an antenna loop for monitoring a cattle passage;

FIG. 2B, presents the prior art portal of FIG. 2A mounted on a rear end of a cattle trailer;

FIG. 3, presents a prior art electronic circuit board connected to the antenna loop of FIG. 2A;

FIG. 4, presents a portal having an RFID reader defining a reduced antenna loop geometry, according to one embodiment;

FIG. 5, presents an antenna loop support structure for a reduced antenna loop geometry, according to another embodiment;

FIG. 6A, presents a method of calibrating an RFID reader, according to one embodiment;

FIG. 6B, presents a method of calibrating an RFID reader, according to another embodiment; and

FIG. 7, presents a method of detecting an RFID tagged object with an RFID reader, according to one embodiment.

It will be noted that throughout the appended drawings, like features are identified by like reference numerals.

### DETAILED DESCRIPTION

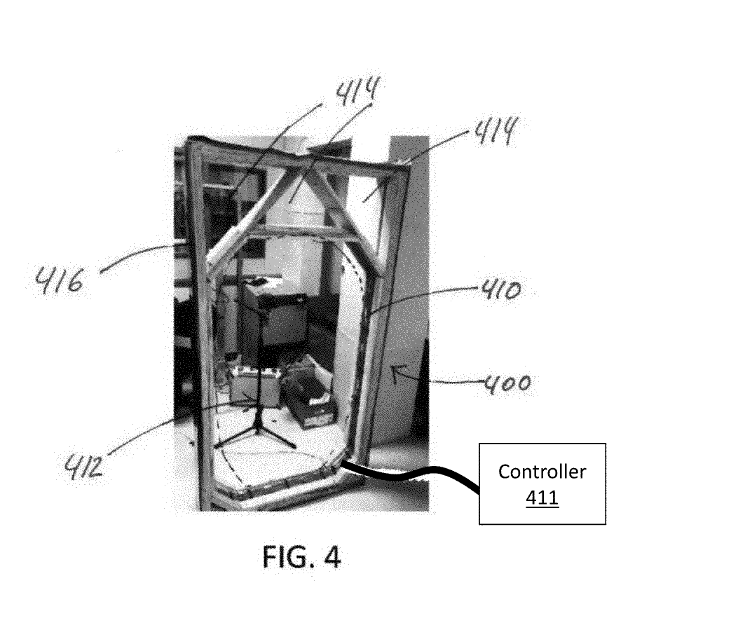

The present system consists of an antenna apparatus that is able to reduce, and in some cases eliminate, RFID tag reading errors when an RFID reader is operating in close proximity to a vibrating or shaking metallic structure. This is accomplished through an adapted design of the RFID reader's loop antenna in terms of shape (geometry) and materials used. A read process must be triggered when the RFID tag is positioned within a livestock passage region that is defined by a portion of an inner perimeter of the loop antenna (i.e. inside of the loop antenna). Therefore, it would be desirable to have a loop antenna structure that is adapted to concentrate the magnetic field within the passage region such as by maximize the magnetic field within the passage region and minimizing the magnetic field as much as possible on an outer side of the livestock passage region (i.e. dead region). The antenna apparatus or RFID reader 400 of FIG. 4 achieves this desired effect with an improved geometry of the loop antenna 410.

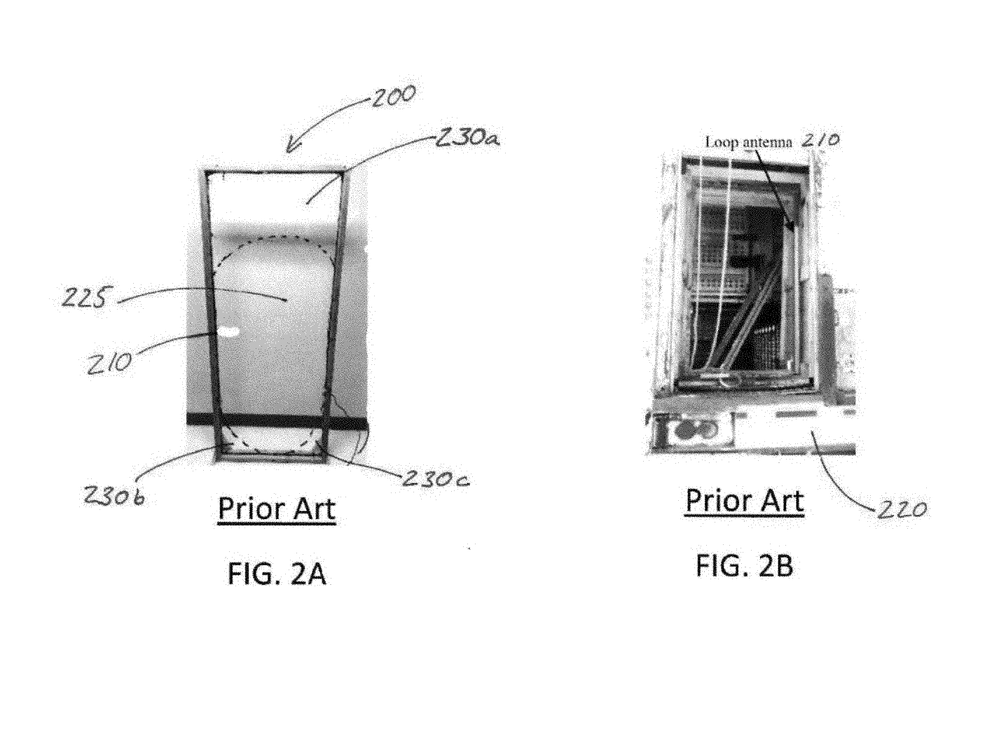

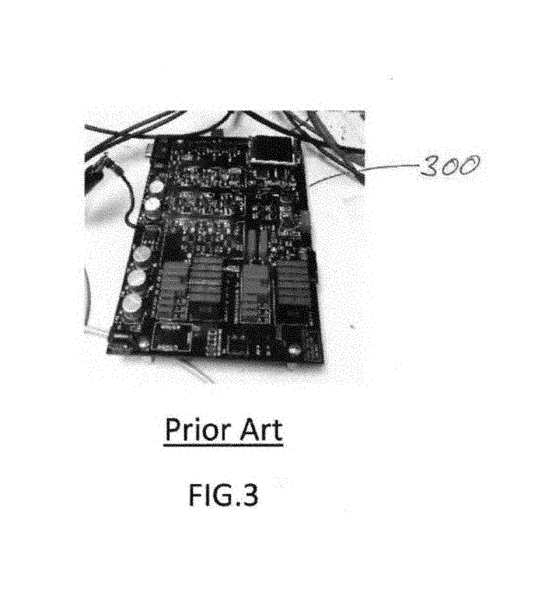

The typical loop antenna shown in prior art FIGS. 2A and 2B does not adequately concentrate the magnetic field within the livestock passage region 225 and leads to wasted energy in the dead regions 230a, 230b and 230c defined by a portion of the loop antenna 210. Consequently, more current is needed in the antenna 210 which leads to stronger magnetic fields reaching the metallic walls of the trailer 220 and hence greater current circulating therein.

Presented in FIG. 4 is an RFID reader 400, according to one embodiment. The RFID reader 400 has a receiver (not shown), an antenna loop 410 and a controller 411 connected to the antenna loop 410. The controller 411 is adapted to control a current level in the antenna loop 410. The antenna loop defines a perimeter according to a reduced passage region 412 (shown by dotted lines) that is still adapted to allow free passage of livestock. Indeed, the antenna loop 410 is adapted to substantially surround the reduced passage region 412 and provides a geometry that requires less current to generate an adequate level of magnetic field within the livestock passage region 412 in order to activate or power the RFID tag 100.

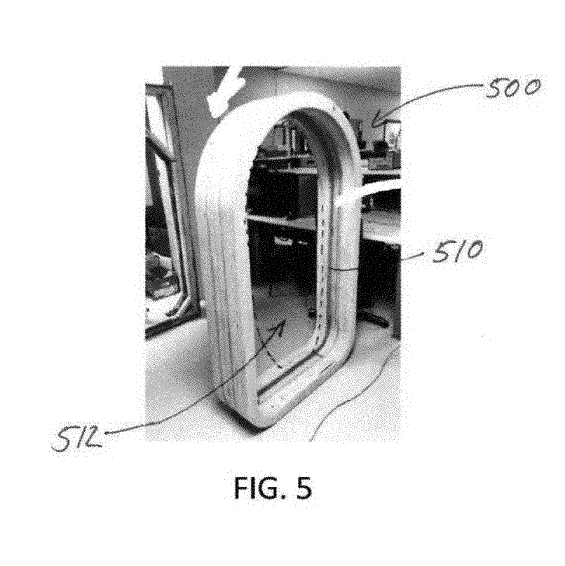

It shall be recognized that similar antenna loop geometries defining a perimeter that is reduced to as much as possible to the passage region of any other kind of herd is possible and that the geometry and the size of the antenna loop is adapted to the herd type and size. For instance, FIG. 5 presents an alternate antenna loop support structure 500 having a geometry adapted to affix an antenna loop (not shown but near region 510) that defines a inner perimeter being, as much as possible, reduced to a livestock passage region 512 (shown by dotted lines).

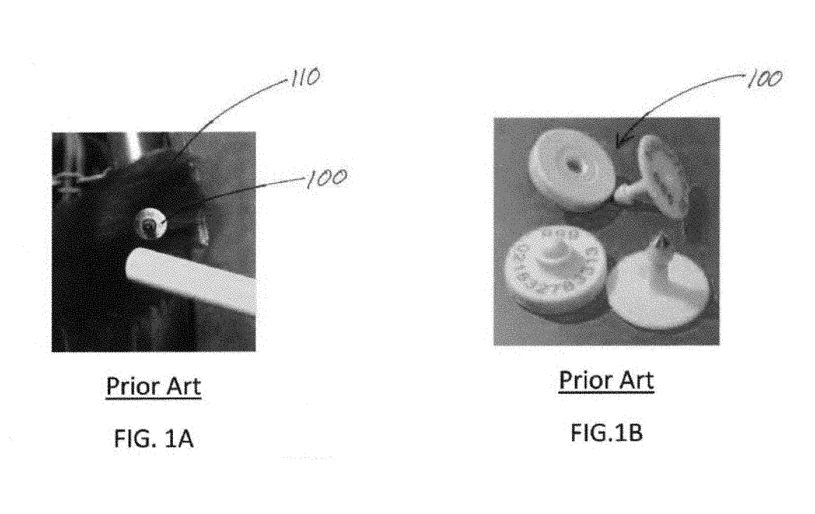

In order to obtain an even better reading of the RFID tag 100, as presented in FIGS. 1A and 1B, the loop antenna 410 having a magnetic shielding can be beneficial, as presented in FIG. 4. Even with reduced current in the loop antenna 410 due to its reduced shape or geometry, when used in an environment such as in a trailer having metallic interior walls, some of the generated magnetic field can still reach the trailer's metallic walls and be strong enough to produce a time-varying wave. The time-varying wave can cause interference with a response wave produced by the activated RFID tag 100 as it is passing through the livestock passage region 412 and prevent adequate reading of RFID tag 100 information by the RFID reader 400. To further concentrate the magnetic field inside the loop antenna or within the livestock passage region 412 and reduce the magnetic field outside the loop antenna (the dead region 414), a magnetic shielding materiel, such as tape, paint, paste or other material producing sensibly the same effect, is used, as presented in FIG. 4. In FIG. 4, a magnetic shielding tape 416 is applied around the loop antenna 410 to magnetically shield the dead regions 414, according to one embodiment. With this shielding approach, while keeping the loop antenna current the same, the magnetic field within the livestock passage region 412 increases significantly and largely exceeds the level required to read the tags 100. Consequently, the applied current to the loop antenna 410 can further be reduced, and still provide reliable RFID readings. A lower current applied to the loop antenna 410 leads automatically to a lower magnetic field emission outside the antenna or in the dead regions 414, in addition to being reduced by the presence of the magnetic shielding material 416. Therefore, the shielding allows the RFID reader 400 to operate with less current and to ‘isolate’ the trailers' metallic walls from the fields generated by the loop antenna 410.

It shall be recognized that in certain situations and environments, the shielding material 416 only partially surrounds the loop antenna 410. The shielding material 416 can still adequately shield the dead regions 414 to sufficiently isolate the trailers' metallic walls from the fields generated by the loop antenna or sufficiently prevent electromagnetic waves produced by the metallic walls to reach the reduced passage of the loop antenna.

A skilled person will recognize that although the above embodiments of the RFID reader 400 have been described with respect to monitoring cattle or livestock, the RFID reader 400 can also be adapted for monitoring a passage of any other type of animal, human being, commercial product or object.

It shall be understood that the RFID reader can be installed in any other environment having shakable metallic walls or members with respect to the antenna loop of the RFID reader.

It shall further be understood that the shaking source of the metallic walls could be caused by a movement of the object being monitored as it is passing through the antenna loop but could also be caused by an independent shaking source such as in a windy environment or where mechanical vibrations are present in the surrounding environment.

It shall further be recognized that the operating current of the antenna loop can be controlled during operation according to a reading made of an RFID tag and automatically calibrated during used. For instance, the RFID reader can make multiple readings while the RFID tagged object passes through the antenna loop. If the number of successful readings is lower than a predetermined threshold, the operating current of the antenna loop can be increased or decreased accordingly.

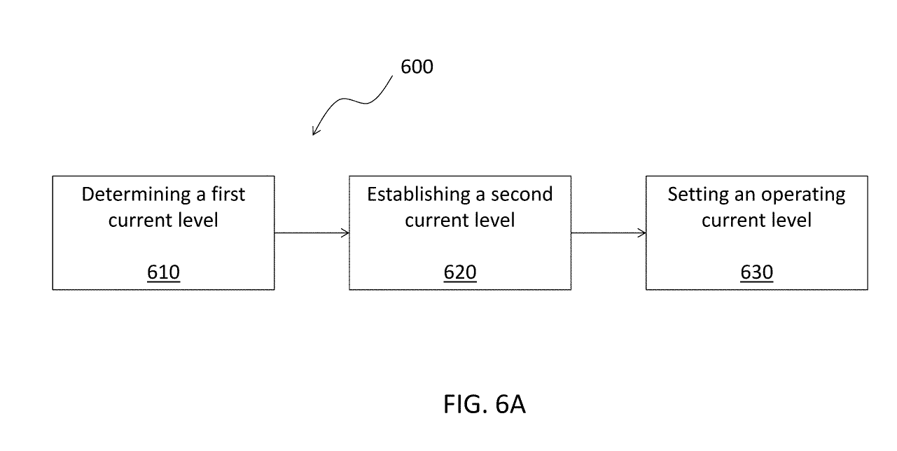

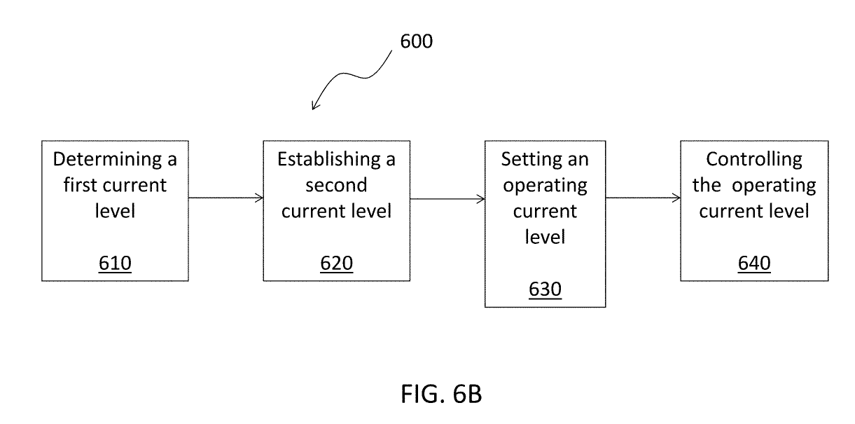

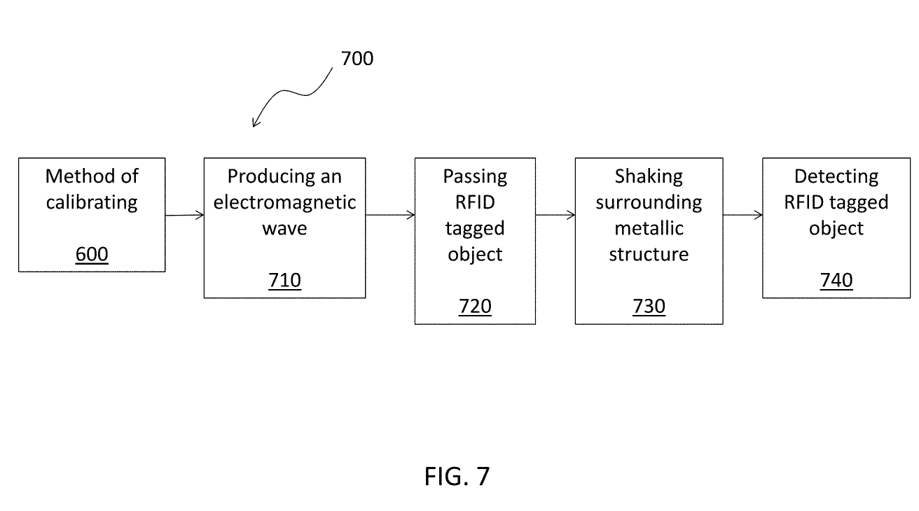

According to another aspect as presented in FIG. 6A, there is a method of calibrating an RFID reader 600 that is placed in an environment having shakable metallic structure with respect to the antenna loop of the RFID reader. The method 600 determines a first current level 610 for the antenna loop that allows detection of the RFID tag when the metallic structure is not shaking but that does not allow detection of the RFID tag as at least one of the objects passes through the opening when the metallic structure is shaking. The method 600 establishes a second current level 620 that is lower than the first current level for the antenna loop and that allows detection of the RFID tag as at least one of the objects passes through the opening when the metallic structure is shaking or not shaking. Then the method 600 sets an operating current 630 of the antenna loop, for post-calibration RFID tag reading using the RFID reader in the environment, according to the established second current.

It shall be recognized that the method of calibrating an RFID reader 600 can be performed during manufacturing the RFID reader or on site during installation. Moreover, the method of calibrating can be performed while operating the RFID reader for auto-calibration purposes.

According to one embodiment as presented in FIG. 6B, the method of calibrating 600 controls 640 the operating current of the antenna loop according to the established second current and a reception rate of response waves produced by the RFID tag. For instance, while in use, the RFID reader can make multiple readings while the RFID tagged object passes through the antenna loop. If the number of successful readings is lower than a predetermined threshold, the operating current of the antenna loop can be increased or decreased accordingly.

According to another aspect, there is a method of detecting 700 an object having an RFID tag with an RFID reader. The antenna loop of the RFID reader is placed in an environment having a metallic structure that is shakable with respect to the antenna loop. The method of detecting 700 uses the method of calibrating 600 the RFID reader and produces 710 an electromagnetic wave with the antenna loop set at the operating current. As the RFID tag passes 720 through the antenna loop, the metallic structure is shook 730. The RFID tagged object is detected 740 during the shaking 730 by powering the RFID tag of the tagged object with the electromagnetic wave and receiving a response wave produced by the powered RFID tag.

It shall be recognized that the RFID tag can be a passive or active RFID tag and that the RFID reader can be a half-duplex RFID reader or a full-duplex RFID reader without departing from the embodiments described herein.

1. A method for calibrating an RFID reader having an antenna loop, the antenna loop defining an opening to allow passage of objects each tagged with an RFID tag, the antenna loop being positioned in an environment having a metallic structure that is shakable with respect to the antenna loop, the method comprising:
determining a first current level for the antenna loop that allows detection of the RFID tag when the metallic structure is not shaking but that does not allow detection of the RFID tag as at least one of the objects passes through the opening when the metallic structure is shaking;
establishing a second current level that is lower than the first current level for the antenna loop and that allows detection of the RFID tag as at least one of the objects passes through the opening when the metallic structure is shaking or not shaking; and
setting an operating current of the antenna loop, for post-calibration RFID tag reading using the RFID reader in the environment, according to the established second current.

2. The method for calibrating of claim 1 further comprising determining a geometry of the antenna for defining the opening that is a reduced opening according to a size and shape of the objects.

3. The method for calibrating of claim 1 further comprising controlling the operating current of the antenna loop according to the established second current and a reception rate of response waves produced by the RFID tag.

4. The method for calibrating of claim 1 wherein the environment having a metallic structure is a trailer having interior walls that are made of metallic members.

5. The method for calibrating of claim 1 wherein the objects are livestock capable of passing through the opening.

6. The method for calibrating of claim 1 wherein the shaking is produced by livestock embarking or disembarking the trailer.

7. The method for calibrating of claim 1 further comprising shielding the opening to prevent a reflected electromagnetic wave produced by the metallic structure from reaching the opening and interfering with a response wave of the RFID tag as it is passing through the opening.

8. The method for calibrating of claim 1 wherein the shielding the opening is to further prevent an originating electromagnetic wave produced by the antenna loop to reach the metallic structure and produce a current in the metallic structure that is strong enough to generate the reflected electromagnetic wave.

9. The method for calibrating of claim 1 wherein the RFID tag is a passive RFID tag.

10. The method for calibrating of claim 1 wherein the RFID reader is a full-duplex RFID reader.

11. A method of detecting objects having an RFID tag with an RFID reader, the RFID reader having an antenna loop, the antenna loop defining an opening to allow passage of the objects, the antenna loop being positioned in an environment having a metallic structure that is shakable with respect to the antenna loop, the method comprising:
determining a first current level for the antenna loop that allows detection of the RFID tag when the metallic structure is not shaking but that does not allow detection of the RFID tag as at least one of the objects passes through the opening when the metallic structure is shaking;
establishing a second current level that is lower than the first current level for the antenna loop and that allows detection of the RFID tag as at least one of the objects passes through the opening when the metallic structure is shaking or not shaking;
setting an operating current of the antenna loop, according to the established second current;
producing an electromagnetic wave with the antenna loop set at the operating current;
passing an RFID tagged object through the opening;
shaking the metallic structure; and
detecting an RFID tagged object during the shaking by powering the RFID tag of the tagged object with the electromagnetic wave and receiving a response wave produced by the powered RFID tag.

12. The method of detecting objects having an RFID tag of claim 11 further comprising controlling the operating current of the antenna loop according to the received response wave.

13. The method of detecting objects having an RFID tag of claim 11 further comprising preventing a reflected electromagnetic wave from interfering with the electromagnetic wave within the opening by shielding the opening.

14. The RFID reading method of claim 11 wherein the shaking of the metallic structure is produced by the passing of the RFID tagged object through the opening.

15. The RFID reading method of claim 11 wherein the objects are livestock each being tagged with a respective RFID tag.

16. An RFID reader system comprising:
an antenna loop defining a reduced passage region according to an item having an RFID tag in order to still allow the item to pass there through;
a controller connected to the antenna loop, the controller being adapted to control a current of the antenna loop in order to produce a controlled electromagnetic field within the reduced passage region and limit propagation of residual electromagnetic field outside the reduced passage region to prevent inducing a current that is strong enough within a surrounding shaking metallic structure such as to produce electromagnetic waves capable of interfering with a response wave produced by the RFID tag as it is passing through the reduced passage region; and
a receiver adapted to receive the response wave produced by the RFID tag as it is passing through the reduced passage region.

17. The RFID reader system of claim 16 wherein the controller is adapted to control the current of the antenna loop according to the received response wave.

18. The RFID reader system of claim 16 wherein the controlled current of the antenna loop is a reduced current that is sufficient to allow the antenna loop to produce the controlled electromagnetic field within the reduced passage region and still power the RFID tag as it is passing there through.

19. The RFID reader system of claim 16 wherein the antenna loop is mounted to a portal structure adapted to be secured to a trailer gate of a trailer adapted to transport livestock and the receiver is adapted to receive the response wave produced by the RFID tag associated to each animal of the livestock as the animal is passing through the reduced passage region.

20. The RFID reader system of claim 16 further comprising a magnetic shield adapted to at least partially prevent electromagnetic waves produced by the surrounding shaking metallic structure to interfere with the response wave of the RFID tag as it is passing through the reduced passage region.
